(19) United States
(12) Patent Application Publication
(10) Pub. No.: US 2011/0022524 A1
(43) Pub. Date: Jan. 27, 2011

(54) PRINTED CIRCUIT BOARD WITH PASSIVE RFID TRANSPONDER

(76) Inventor: Brian H. Monahan, Santa Cruz, CA (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/821,532

(22) Filed: Jun. 23, 2010

Related U.S. Application Data
(60) Provisional application No. 61/227,221, filed on Jul. 21, 2009.

(51) Int. Cl. G06Q 10/00; G06F 19/00; G06F 15/00; G06K 19/07; G06Q 50/00

(52) U.S. Cl. 705/302; 702/81; 702/188; 235/492

(57) ABSTRACT

A process is provided for testing or operating an integrated circuit that includes providing a passive radio frequency identification transponder in electrical communication with the integrated circuit. The integrated circuit is associated with a printed circuit board or analog circuitry. The passive radio frequency identification transponder is shielded from the integrated circuit with a ferrite material ground in power planes as well as radiated emissions from the printed circuit board when the printed circuit board is energized. Information about the function of the integrated circuit is communicated to a remote location with an antenna coupled to the transponder in response to an external signal that provokes the communication so as to test or operate the integrated circuit. An assembly is provided that includes a printed circuit board or analog circuitry inclusive of a central processing unit that defines a ground plane and a power plane, and provides irradiated emissions upon the central processing unit being energized. A passive radio frequency identification is also present. An antenna circuit is in electrical communication with the passive radio frequency identification transponder and includes a coil antenna or a patch antenna. A ferrite loaded material is positioned intermediate between the radio frequency identification transponder and the printed circuit board or analog circuitry to shield the radio frequency identification transponder from the ground plane, the power plane, and radiated emissions when produced by the printed circuit board or the analog circuitry being energized.

### CROSS REFERENCE TO RELATED APPLICATION

This application claims priority of U.S. Provisional Patent Application Ser. No. 61/227,221 filed Jul. 21, 2009, which is incorporated herein by reference.

### FIELD OF THE INVENTION

The present invention relates generally to Radio Frequency Identification (RFID), and in particular to the structure of an RFID transponder integrated with a printed circuit board assembly (PCBA), and various applications of this structure.

### BACKGROUND OF THE INVENTION

Over the past few years, the use of RFID transponders has expanded tremendously in a broad range of areas, ranging from inventory tracking to passport security. There are generally two types of RFID technology: active RFID tags and passive RFID tags. Active RFID tags contain a battery and can transmit signals autonomously. Passive RFID tags, on the other hand, have no battery and require the reception of an external signal to provoke the tag's own signal transmission.

The ability of a passive RFID to receive and transmit information without the use of a direct power source provides a number of benefits. One area where these benefits may be utilized is in the design, testing, and operation of a printed circuit. Such circuits may go through a variety of testing during the manufacturing process, and a method of further automating this testing would be beneficial. In many cases, the supply chain for such circuits spans various parts of the world, and thus, it would also be beneficial to have a method of automatically reading information or instructions relevant to the circuit. Once the circuit reaches the consumer, there may be restrictions that a manufacturer would like to put on its use. A method of automating this process would very beneficial. Each of the above applications, and a variety of others, can be facilitated through the use of RFID. There thus exists a need for a structure which integrates an RFID transponder with a printed circuit board assembly (PCBA).

### SUMMARY OF THE INVENTION

A process is provided for testing or operating an integrated circuit that includes providing a passive radio frequency identification transponder in electrical communication with the integrated circuit. The integrated circuit is associated with a printed circuit board or analog circuitry. The passive radio frequency identification transponder is shielded from the integrated circuit with a ferrite material ground in power planes as well as radiated emissions from the printed circuit board when the printed circuit board is energized. Information about the function of the integrated circuit is communicated to a remote location with an antenna coupled to the transponder in response to an external signal that provokes the communication so as to test or operate the integrated circuit.

An assembly is provided that includes a printed circuit board or analog circuitry inclusive of a central processing unit that defines a ground plane and a power plane, and provides irradiated emissions upon the central processing unit being energized. A passive radio frequency identification is also present. An antenna circuit is in electrical communication with the passive radio frequency identification transponder and includes a coil antenna or a patch antenna. A ferrite loaded material is positioned intermediate between the radio frequency identification transponder and the printed circuit board or analog circuitry to shield the radio frequency identification transponder from the ground plane, the power plane, and radiated emissions when produced by the printed circuit board or the analog circuitry being energized.

### BRIEF DESCRIPTION OF THE DRAWING

FIG. 1 is an exploded view of an inventive printed circuit board assembly; and

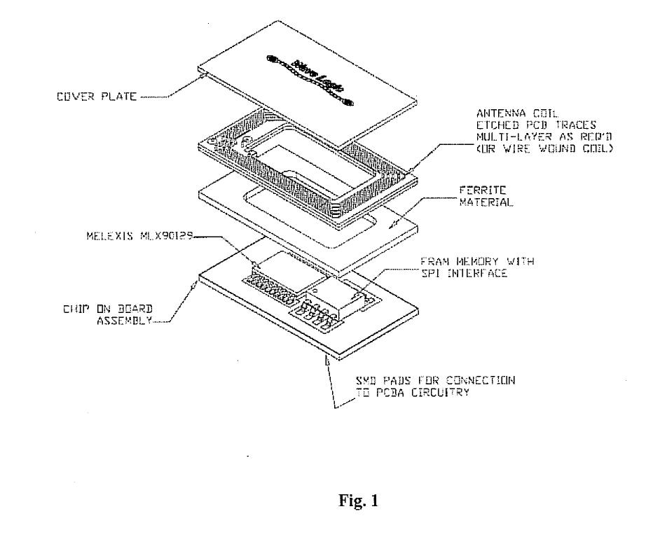

FIG. 2 is a bottom view of the footprint and pin configuration of the assembly of FIG. 1.

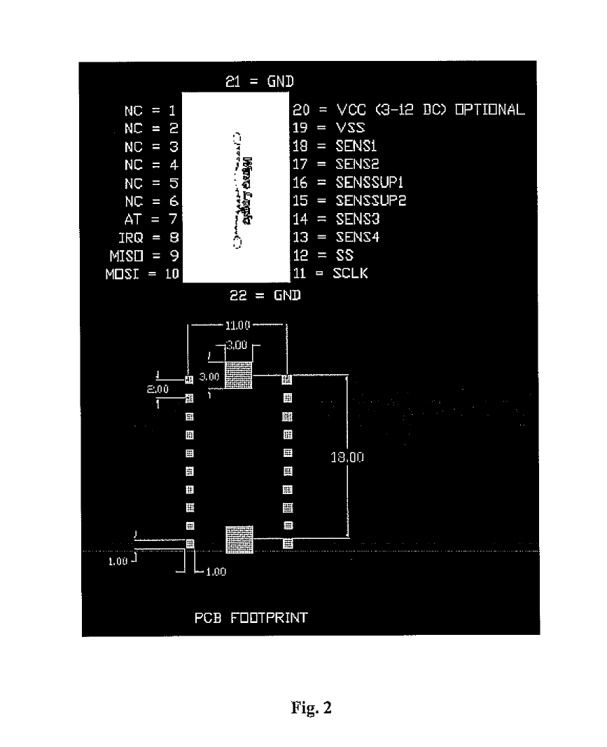

### DETAILED DESCRIPTION OF THE INVENTION

The present invention provides a process of enforcing computer and software manufacturer use restrictions after a user takes possession of the equipment. As a result, additional features and terms licenses are amenable to remote enforcement. To enable this process, structure is provided that involves the integration of an RFID transponder with a printed circuit board assembly (PCBA). The invention has a variety of novel applications for such a structure. While the present invention is discussed hereafter in the context of its preferred embodiments, and in particular, its use in conjunction with a computer motherboard, this is not intended to be a limitation upon the use thereof but rather to afford an intuitive and illustrative usage setting.

Referring to the figures, an inventive structure is shown generally at 10 and includes a PCBA having digital and/or analog circuitry 12. This circuitry illustratively includes a central processing unit (CPU) microcontroller 14. A passive RFID chip 16 is optionally mounted on a separate substrate relative to the PCBA. The inclusion of off-chip memory is optional. An exemplary commercially available integrated circuit RFID chip is Melexsis MLX90129 transponder IC with SPI interface has 512 bytes (4,096-bits) of EEPROM memory. It is appreciated that FRAM memory has advantages over EEPROM memory of lower power consumption, superior write capabilities, and faster memory access.

Off-chip memory illustratively includes an EEPROM or FRAM. Off-chip memory 18 is optionally mounted on the RFID substrate or a separate memory substrate. It is appreciated that off-chip memory size is readily sized based on user specifications and illustratively includes 512, 1028, and higher byte sizes. Wiring such as a serial peripheral interface (associated with the off-chip memory) provides electrical communication interconnection between the PCBA and the substrate supporting off-chip memory, RFID tag, or a combination of these elements. A layer of ferrite loaded material 20 is mounted to this substrate, so as to shield the RFID tag from the PCBA ground and power planes and the radiated emissions from the PCBA circuitry. An exemplary ferrite loaded material is sold under the trade name Eccopad®.

According to the present invention, it is preferred that the ferrite loaded material layer 20 is a distinct freestanding layer relative to the antenna 21. As a result, the present invention retains a modular quality that allows for antenna 22 and PCBA 14 to be selected that is tailored for specific applications without otherwise modifying the device. This is in contrast to the conventional wisdom that ferrite shielding is best positioned as an adjunct within an antenna chip.

An antenna circuit 22 illustratively includes a coil antenna or a patch antenna is mounted to in communication with the RFID tag 16. It is appreciated that the antenna is optionally an etched PCB trace multi-layer or wire wound coil construct. The substrate 24 preferably includes solder-mask-defined (SMD) pads 26. The substrate 24 including the mounted ferrite material 20 and antenna coil 22 is soldered directly to the PCBA 14, providing for direct connection to the PCBA circuit architecture. Preferably, the RFID chip 16 has a serial peripheral interface (SPI). SPI is a synchronous serial data link that operates in full duplex, i.e. data-carrying signals can go in two directions simultaneously. The SPI allows the RFID 16 to communicate with the PCBA 14 and/or its various integrated components, such as the CPU microcontroller. The memory 18 of the inventive structure 10 can be shared and accessed through a conventional RF interface, illustratively including 13.56 MHz ISO15693 protocol, as well as through communication lines to a host CPU microcontroller, such as SPI, address/data bus, I 2C, SMBus, UART, or the like. A cover plate 28 protects the remaining components of the structure 10 from environmental exposure.

The above-described structure, integrating the RFID chip with the PCBA, along with other components, will hereinafter be referred to as the “RFID-PCB device”.

While the RFID-PCB device has been described above in one particular embodiment, a number of variations of this design are possible. The position of the RFID chip relative to the antenna, the ferrite material, and off-chip memory, for example, need not be as described. The off-chip memory may be placed, for example, on a separate substrate, rather than on the same one as the RFID. The inclusion of peripheral components such as the off-chip memory and ferrite material is not necessary; however, these components may provide utility in some of the applications described below. It is appreciated that a PCB substrate is either a rigid ceramic or, alternatively, a flexible laminate material. A flexible laminate material substrate facilitates employing antenna and chip modules as a continuous flex circuit with the antenna folded above the chip modules.

The design and testing of an integrated circuit benefits from the usage of an inventive structure. An integrated circuit is a complex structure, interacting with a variety of external devices and comprising numerous individual components. The testing of a product comprising an integrated circuit can be quite rigorous. Presently, test data may be loaded onto the memory of a device through a computer connection, such as a serial port. The inventive structure allows for a much more automated process. The below example describes this application in the usage setting of a computer motherboard.

A computer motherboard including an inventive RFID-PCB structure 10 provides a benefit during the testing phase of circuitry of the motherboard with resultant test data being written to the RFID transponder 16 with an RFID transceiver at each test station. Alternatively, in a self-test mode, the test data is written to the RFID transponder 16 directly by the motherboard CPU 14 and supporting software or via the test equipment's electrical connections to the motherboard. Manufacturing and test data are optionally stored in the off-chip memory 18. As a result, in subsequent processes the data is available for making process decisions, such as “unit passed testing” or “unit failed testing” thereby enabling automation equipment to route the assembly to the appropriate work cell where the next operation can be performed (e.g. rework, DRAM memory failure). Critically, data is read from the RFID-PCB structure 10 even when the motherboard is in a powered-off state owing to the resort to a passive RFID transponder in an inventive structure 10.

Some examples of information that is stored in the off-chip memory include, but are not limited to, error code information, memory dumps, data codes, or firmware vision. A motherboard CPU, for example, writes error codes to the off-chip memory 18 of the RFID transponder 16 such that in a situation where the motherboard fails, the error message provides information to remote technicians to understand the circumstances leading up to the failure and provide information to facilitate a remedy. The information is communicated by the transponder 16 via a wireless network in range of structure 10. It is appreciated that a mobile system containing the structure 10 can communicate operational data to a remote site dynamically as it translates between cells of a network or alternatively does so at preselected times or operational situations such as system inactivity.

The RFID-PCB structure 10 optionally includes a variety of integral or peripheral sensors, such as a temperature sensor, that are programmed for a preselected operating condition. In the case of a temperature sensor, for example, the maximum operating temperature of the motherboard. Suppose the maximum specified operating temperature of the motherboard is 85° C. The internal temperature sensor of the RFID-PCB device might be set to a preselected threshold of 95° C. and in the event that the end user has operated motherboard in a hot environment and/or has disabled the internal fan or blocked the vents. The motherboard eventually reaches a temperature of 95° C., the temperature threshold, and subsequently a corresponding error byte is written to off chip memory. Temperature continues to rise and eventually the CPU is damaged, even though the exceeding temperatures were not high enough to cause any visible signs of overheating. The repair technician could determine the cause of the board failure from the damaged or even nonfunctional motherboard by reading the off-chip memory using a wireless transceiver and learn that the maximum operating temperature of the motherboard was exceeded in breach of the warranty. Similar examples include the use of accelerometers or shock sensors to determine if a computer has been dropped and moisture sensors to determine if a liquid has been spilled on the computer, respectively. It is appreciated that a computer inclusive of inventive structure 10 operating in a complex system such as a motorized land vehicle, aircraft, or spacecraft exacts additional benefits in that operational diagnostics are readily performed that when coupled with an alert system allow for maintenance, product recalls, and usage-based reengineering prior to actual catastrophic failure. By extension, maintenance schedules are readily customized to account for the actual performance of the system. For example, a system is monitored by the structure 10 and when an operational parameter exceeds a preselected threshold or window, an alert is communicated that service is required. With the threshold or window chosen to afford a margin before catastrophic failure, service becomes proactive thereby allowing for more reliable operation and lessened unscheduled service. Transportation, manufacturing, and power distribution systems containing inventive structure 10 in particular benefit from the passive operational communication so afforded. In the context of the present invention, an alarm system includes an auditory alarm, an electronic message, an auditory synthetic voice notice, and other conventional forms of digital communication. It is appreciated that content of such an alarm system, the level of detail as to the sensed operational parameter, and/or the recommended service action are readily specified.

Another example application of the RFID-PCB device is its use as a manifest for providing information in various build or assembly processes. For example, a personal computer (PC) is often customized before being purchased by a consumer. The RFID-PCB structure 10 stores various information pertaining to the PC, illustratively including hard drive size, DRAM memory capacity, language preference for manuals, country power cord requirements, software options to be loaded, and other configurations. The instructions can be read by an RFID transceiver at the assembly site. Different companies, located in disparate remote locations, execute individual assembly steps; however, storing specifications in the device itself allows for a streamlined and efficient assembly process.

In another application, a unique serial or identification number corresponding to the RFID-PCB structure 10 can be associated with the serial number of a motherboard or other devices, such that it would be known if a motherboard or other device was swapped out of a computer in a fraudulent effort to obtain warranty coverage for a computer repair.

In a similar manner, the RFID-PCB structure 10 is beneficial for providing controlled access to software that is being used by the product in which it is located. That is, software installed on the product is enabled/disabled with an RFID transceiver. In one embodiment, this could be implemented through the storage of a software authorization byte(s) on the off-chip memory. This is communicated to the RFID-PCB structure 10 by the RFID transceiver. Once the defined memory locations are programmed with the corresponding software authorization byte(s), the motherboard software verifies the code was authorized by reading the memory location defined in the off-chip memory 18, enabling the code to be executed. If the required enabling byte was not written into the off-chip memory, the code would fail to initialize. This would allow one software image to be loaded to disk, RAM or ROM, and the configuration for allowing program execution could be controlled at a later stage of production or by an authorized reseller or service partner.

Storing authorization codes in the RFID off chip memory also allows for a much more efficient assembly and installation process. For example, all laptops produced by a company can be loaded with the same set of software programs, and through the authorization byte scheme described above, access can be limited only to those programs which the customer has purchased. If the customer later wishes to purchase additional software, this can be done through taking the laptop to a service center and having an authorization byte transmitted to the RFID.

The present invention is also considered to provide particular benefit in the development and usage of implanted electrically powered medical devices. Such medical devices include pacemakers and ventricular assist devices. Owing to the ability to wirelessly monitor function of the device as well as sensors associated with an inventive structure, design and/or operational improvements to the medical device are readily iterated.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

1. A process for testing or operating an integrated circuit comprising:
providing a passive radio frequency identification (RFID) transponder in electrical communication with the integrated circuit, the integrated circuit associated with a printed circuit board;
shielding the RFID transponder with a ferrite material; and
communicating information about a function of the integrated circuit to a remote location with an antenna coupled to the transponder in response to an external signal that provokes the communicating step to test or operate the integrated circuit.

2. The process of claim 1 wherein the integrated circuit is a central processing unit (CPU).

3. The process of claim 2 wherein the CPU is on a motherboard.

4. The process of claim 1 wherein the function is testing during manufacture.

5. The process of claim 1 wherein the function is operation by an end user.

6. The process of claim 4 further comprising storing the information about the function to a memory coupled to the RFID transponder.

7. The process of claim 6 wherein the memory is off chip.

8. The process of claim 1 further comprising placing a serial port interface intermediate between the RFID transponder and the integrated circuit.

9. The process of claim 1 further comprising changing software authorization through a signal wirelessly transmitted from the remote location to the antenna and the RFID transponder.

10. The process of claim 6 further comprising coupling a sensor to the RFID transponder to monitor an operational parameter of the integrated circuit and storing the operation parameter to the memory.

11. The process of claim 10 further comprising transferring data relating to the operational parameter wirelessly to an RFID transceiver.

12. The process of claim 10 further compromising determining if a product warranty has been breached based on the data.

13. The process of claim 1 wherein the integrated circuit is part of an implanted medical device.

14. The process of claim 1 wherein the integrated circuit is attached to a vehicle and the external signal is provided by successive transceiver nodes of a network.

15. The process of claim 1 further comprising electronically coupling the integrated circuit to an environmental sensor and upon a sensor signal exceeding a preselected threshold or window, an alert signal is the information communicated.

16. The process of claim 15 further comprising the integrated circuit storing error codes communicated as the alert signal.

17. The process of claim 1 wherein the remote location is a site of subsequent partial assembly of the integrated circuit into a device.

18. An assembly comprising:
a printed circuit board or analog circuitry inclusive of a central processing unit defining a ground plane and a power plane, and producing radiated emissions upon being energized;
a passive radio frequency identification (RFID) transponder;
an antenna circuit in electrical communication with said RFID transponder, said antenna circuit comprising an a coil antenna or a patch antenna; and
a ferrite loaded material positioned intermediate between said RFID transponder and said printed circuit board or analog circuitry to shield said RFID transponder from the ground plane and the power plane and radiated emissions when said printed circuit board or said analog circuitry is energized.

19. The assembly of claim 18 further comprising off-chip memory coupled to said RFID tag.

20. The assembly of claim 19 wherein said off-chip memory is FRAM memory.

21. The assembly of claim 19 wherein said off-chip memory stores at least datum of error code information, memory dumps, data codes, or firmware vision.
